(19) United States
(12) Patent Application Publication
(10) Pub. No.: US 2012/0273077 A1
(43) Pub. Date: Nov. 1, 2012

(54) Flow resistor

(75) Inventors: Walter LANG, Bremen (DE); Kai BURDORF, Syke (DE)

(73) Assignee: RM TE ME NA GMBH, Felsberg (DE)

(21) Appl. No.: 13/404,061

(22) Filed: Feb. 24, 2012

(30) Foreign Application Priority Data
Feb. 25, 2011 (DE) DE 102011000938.8
Jun. 17, 2011 (DE) DE 102011051140.7

(51) Int. Cl. F16L 55/027

(52) U.S. Cl. 138/40

(57) ABSTRACT

A flow resistor having a flow conduit with an inlet opening and an outlet opening, and a membrane forming a wall of the flow conduit, and a cross section of the flow of the flow conduit can be varied by exerting pressure on the membrane. The flow resistor has a cavity containing a medium with a positive temperature coefficient and a flow chamber; the membrane separates the cavity from the flow chamber and is both the wall of the cavity as well as the wall of the flow conduit, wherein the flow conduit is constructed as a helical recess, open to the membrane, in a surface of a lower cover that closes the flow chamber, wherein an inflow opening is arranged in the center of an area fixed by the flow conduit and wherein an outflow opening is arranged on the edge side.

The invention relates to a flow resistor comprising a flow conduit with an inlet opening and an outlet opening as well as a membrane forming at least in sections a wall of the flow conduit, whereby a cross section of the flow of the flow conduit can be varied by exerting pressure on the membrane.

A flow resistor or a variable current resistor is known from DE-A-102 54 312. The current resistor known from DE-A-102 54 312 comprises a fluid line with a fixed length that connects a fluid inlet to a fluid outlet. Furthermore. An apparatus for varying the cross section of flow of the fluid line over a predetermined length of the line is provided for adjusting the current resistance defined by the fluid line, whereby the ratio of predetermined length of the fluid line to its characteristic diameter is >500. The apparatus for varying the cross section of flow is constructed in such a manner as to exert a pressure from the outside onto wall sections of the fluid removal line that is independent of the pressure of a medium in the fluid line. The fluid line is formed by a conduit formed in the surface of a substrate and by a membrane covering the conduit. The apparatus for varying the cross section of flow of the fluid line is an apparatus for deflecting the membrane, in particular an apparatus for loading the membrane with a pressure.

The article by P. Cousseau et al., “Improved Micro-Flow Regulator for drug delivery systems”, 2001 IEEE, pp. 527-530, discloses a current regulator that is supposed to deliver a constant current rate within a predetermined operating pressure range in spite of a pressure difference. The current regulator comprises a membrane formed in a first substrate in which an inlet opening is provided in its center. A fluid chamber is formed in a second substrate and comprises an outlet opening. A helical, capillary conduit open at the top is formed in the bottom of the fluid chamber. The two substrates are connected to one another in such a manner that the membrane closes off the fluid chamber formed in the second substrate at the top. If a pressure is exerted on the membrane, it is at first deflected in the middle until it strikes the bottom of the fluid chamber in the middle. In this state the inlet opening through the membrane overlaps with the inner end of the conduit formed in the bottom so that the inlet opening and the conduit are connected in a fluidic manner. Upon an increasing deflection of the membrane it forms together with the conduit a current resistor whose length increases with increasing deflection of the membrane. Thus, a uniform current rate is retained in spite of pressure differences on account of the increasing current resistance.

A flow-through amount regulator is described in DE 199 143 81 that comprises a base plate, a cover plate connected to the base plate and with an inlet and an outlet as well as an adiabatic chamber formed in the cover plate and arranged on the upper surface of the base plate. Furthermore, a membrane connected to the upper circumference of the adiabatic chamber is provided, whereby the membrane forms a refrigerating agent space into which refrigerating agent is filled in, which refrigerating agent space is arranged between the cover plate and the adiabatic chamber. Furthermore, a disk for sealing the pressure-producing medium is connected to the bottom surface of the adiabatic chamber and an apparatus for heating the thermal expansion solution filled into the pressure-producing space is provided.

A thermopneumatic microvalve on the basis of phase change material is described in DE 10 2008 054 220 A1 that makes possible a regulation of, e.g., gas flows as a function of the ambient temperature. The microvalve comprises a valve chamber with an inlet conduit and an outlet conduit. Furthermore, an expansion chamber is provided that contains a working medium that expands upon being heated. The spaces are separated by a membrane, whereby in the open state of the microvalve the membrane permits a flowthrough of a fluid from the inlet conduit through the valve chamber to the outlet conduit, whereas in the closed state a deformation of the membrane is brought about by the expansion of the working medium which presents a fluid from flowing through from the inlet conduit through the valve chamber to the outlet conduit.

DE 690 14 759 T2 describes a boron nitride membrane in a semiconductor wafer structure. The layer structure comprises an upper wafer part, a lower wafer part, whereby the upper and lower wafer parts are coupled in such a manner to one another that they determine a hollow space. Furthermore, a membrane is provided, which membrane is coupled to the lower wafer part and is formed substantially from hydrogen-free boron nitride with a nominal composition of B₃N. The membrane extends in the hollow space between the upper and the lower wafer part and forms a structural component within the hollow space.

US 2003/0010948 A1 describes a flow-through amount regulator comprising a second substrate with a flexible, thin film arranged between the first substrate that comprises a heating mechanism and between a third substrate that comprises a sealing area. The first substrate and the second substrate enclose an inner space that is arranged adjacent to the heating mechanism and is filled with an expandable material. The sealing area and the flexible, thin film form a valve together.

JP 09330132 A discloses a semiconductor pressure sensor module with valve control and pressure control. In order to construct the semiconductor pressure sensor with a valve, it is provided that a semiconductor pressure sensor and a semiconductor valve are arranged on the upper side of a substrate whereby a housing is arranged on the substrate surface that covers both. Measuring gas can be introduced into the housing, whereby the interior of the housing forms a pressure chamber. A semiconductor valve can be controlled open/closed in that a thermally expanding pressure fluid is heated, as a result of which a diaphragm is bent and a passage opening is open/closed and frees the flowthrough of a gas into the pressure chamber.

DE-A-196 50 115 discloses a medicament dosing device comprising a replaceable unit as well as a permanent unit. The replaceable unit comprises a fluid reservoir for receiving a liquid medicament that can be put under pressure, a temperature sensor for detecting the temperature of the liquid medicament, a fluid conduit provided with a flow resistor and fluidly connected to the fluid reservoir and comprises a hose device connected to the fluid conduit. The permanent device comprises a squeeze valve device for compressing the hose device and comprises a control device that is coupled to the temperature sensor and the squeeze vale device in order to control a flow rate of the liquid medicament by a cadenced activation of the squeeze valve device as a function of the detected temperature.

Furthermore, perfusion pumps, also called injection pump or perfusor, are known from the prior art that serve for the continuous, intravenous administration of medicaments over a fairly long time period. Two variants of perfusion pumps are distinguished. In a first variant a piston of a drawn-up standard syringe is shifted in such a manner with an electric motor that a certain amount of liquid is dispensed in a predefined time period. A physician gives the dose and the time to an electronic device that then controls the motor and the piston. The medicament is supplied to the patient via a hose with a cannula.

A second variant is constructed in a substantially simpler manner and does not require an electronic device or an electric drive. The medicament solution to be administered is pressed with a syringe into an elastic balloon or hose so that the latter expands. A non-return valve then closes the balloon on the input side while the returning elastic forces dispense the medicine into the patient via a hose with a cannula.

In such a device the dosage and the flow rate are given via a flow resistor (restriction stretch) that is integrated in the course of the hose preferably in the form of a very thin glass capillary. Such an embodiment is distinguished by its passive method of operation and simplicity and is economical and can be flexibly used at any time.

In acceptable deviations from the theoretical flow rate can occur in the above-described embodiments of flow resisters conditioned by manufacturing tolerances.

Since the medicaments to be administered are as a rule aqueous solutions whose viscosity is comparatively heavily temperature-dependent, the theoretical flow rate is also heavily temperature-dependent. For pure water the viscosity at a temperature 5° C. is, for example, approximately 1.5 mPas, whereas it drops at a temperature of 25° C. to 0.9 mPas. This means that an amount of liquid that is administered at a temperature of 25° C. in 3 hours would require approximately 5 hours for running through at a temperature of 5° C.

The disadvantages described above have the consequence that passive perfusion pumps could not and cannot be successful in the market.

Starting from the above, the present invention has the basic problem of further developing a flow resistor of the initially cited type, in particular for usage in perfusion pumps, in such a manner that a flow resistor with a temperature-stabilized flow rate is made available.

The invention solves the problem in that the flow resistor comprises a cavity containing a medium with a positive temperature coefficient and comprises a flow chamber, that the membrane divides the cavity from the flow chamber and is both the wall of the cavity as well as at least in sections the wall of the flow conduit, that the flow conduit is constructed as a helical recess, open to the membrane, in a surface of a lower cover that closes the flow chamber, that an inflow opening is arranged in the center of an area fixed by the flow conduit and an outflow opening is arranged on the edge side in such a manner that the flow conduit can be varied as a function of the temperature T of the medium as regards the cross-section of its flow as well as regards its length on which the membrane rests.

It is provided that the flow resistor comprises a cavity that contains a medium with a positive temperature coefficient, whereby the membrane is at the same time the wall of the cavity as well as at least in sections the wall of the flow conduit. The flow conduit is constructed as a helical recess, open to the membrane, in a surface of a lower cover that closes the flow chamber. An inflow opening is arranged in the center of an area fixed by the flow conduit and an outflow opening is arranged on the edge side.

The invention is based on the concept of enclosing a medium that expands upon rising temperature in a cavity, whereby the membrane is constructed as a wall of this cavity that is at the same time a wall of the flow conduit.

If the medium enclosed in the cavity is heated, the membrane deflects and curves against the helical recess so that the cross section of the flow conduit is reduced and the effective length of the flow conduit is enlarged. Consequently, the resistance of the flow conduit increases and the flow rate is reduced. Given appropriately designed geometries the increase in the flow rate is compensated by the temperature-conditioned decrease of the viscosity of the fluid.

The flow conduit is formed as a helical recess, open to the membrane, in a surface of the lower cover that closes the flow chamber.

Upon thermal expansion of the enclosed medium the membrane contacts the surface of the lower cover lying opposite it. If the medium expands further upon an increase of temperature then the contact area enlarges. The membrane is at least in sections a wall of the flow conduit that is open to the membrane.

In a helical embodiment of the flow conduit the inflow opening is in the center of the area fixed by the flow conduit while the outflow opening is arranged on the edge side.

The flow conduit is closed where the membrane rests on the flow conduit. Consequently, a differently long flow conduit is produced as a function of the membrane curvature and of the size of the contact area, which then acts as a variable, temperature-dependent resistor.

Thus, the resistance of the flow conduit varies with the bending of the membrane, that is, as a function of the temperature. Even in this instance the flow rate can be stabilized with respect to the temperature given the appropriate dimensioning of the components.

The flow conduit preferably extends over an area that corresponds to the extension of the area of the pressure-loaded range of the membrane.

According to a preferred embodiment the cavity is formed in an upper surface of a substrate and the flow chamber is formed in a lower surface of the substrate, which cavity is closed by an upper cover and the flow chamber is closed by the lower cover. The lower cover comprises the inlet and outlet openings. The membrane running between the cavity and the flow chamber is constructed as an integral component of the substrate.

Another preferred embodiment is distinguished in that the cover for the cavity is constructed as a glass cover and the cover of the flow chamber or the cover receiving the flow conduit is constructed of plastic and comprises the in- and outlet opening.

The substrate is preferably constructed as a silicon substrate or silicon wafer or of plastic.

When using a silicon substrate the membrane is produced using a wet or dry chemical process. The silicon substrate is preferably thermally oxidized in order to achieve extensive chemical inactivity and biocompatibility.

In another preferred embodiment the glass cover is a glass wafer connected by anodic bonding to the Si substrate. The cavity preferably receives a gas or liquid as medium. In the case of a filling with gas the glass wafer is preferably bonded on in an appropriate gaseous atmosphere. When a liquid is used as medium the cavity is filled after the bonding through conduits that are subsequently closed again.

The lower cover of the flow space together with hose flanges for the supply and removal of medicaments is preferably manufactured as an injection-molding part of plastic or of silicon substrate, in particular of oxidized silicon.

Other details, advantages and features of the invention result not only from the claims, the features to be gathered from them, either alone and/or in combination, but also from the following description of preferred embodiments to be gathered from the drawings in which:

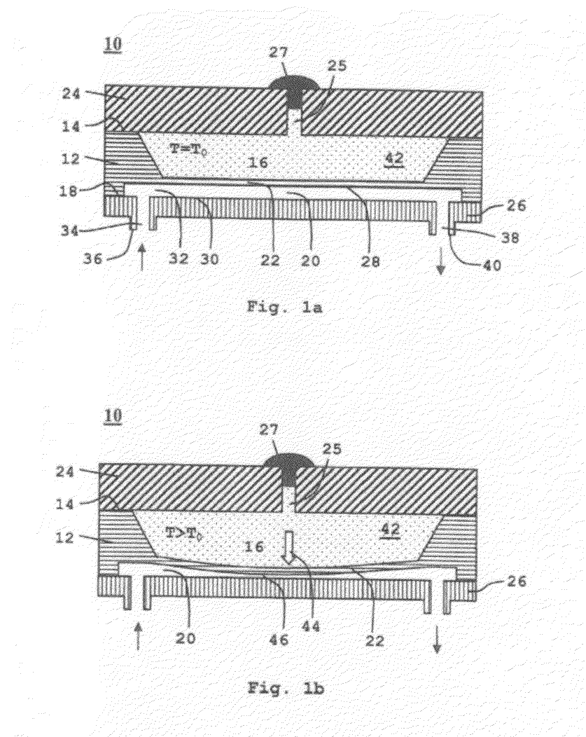

FIG. 1a, 1b show a schematic sectional view of a first embodiment of a temperature-compensated flow resistor at different temperatures,

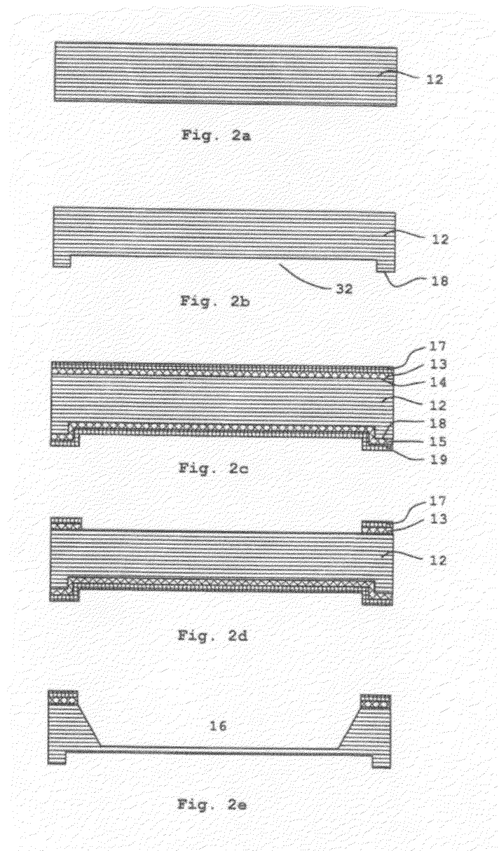

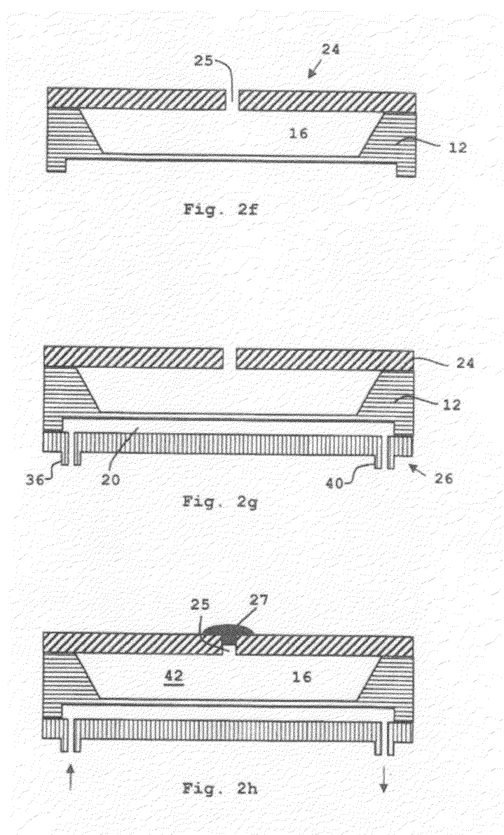

FIG. 2a-2h show a schematic sectional view of the first embodiment of a temperature-compensated flow resistor in different manufacturing steps,

FIG. 3 shows a schematic sectional view of a second embodiment of a temperature-compensated flow resistor,

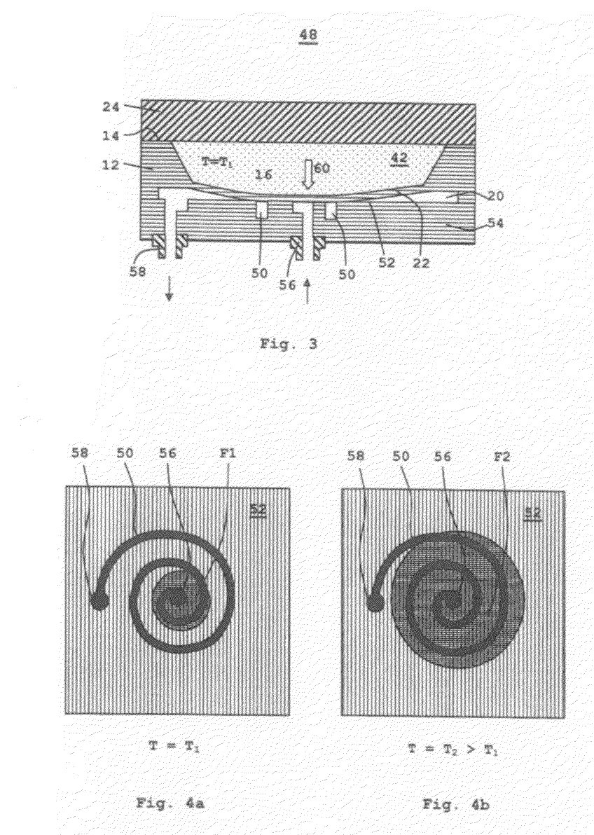

FIG. 4a, 4b show a top view onto a flow conduit covered by a membrane at different temperatures, and

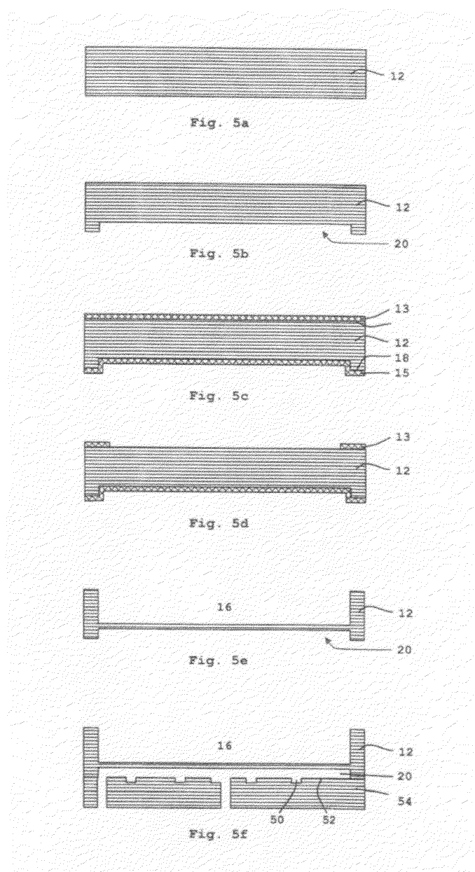

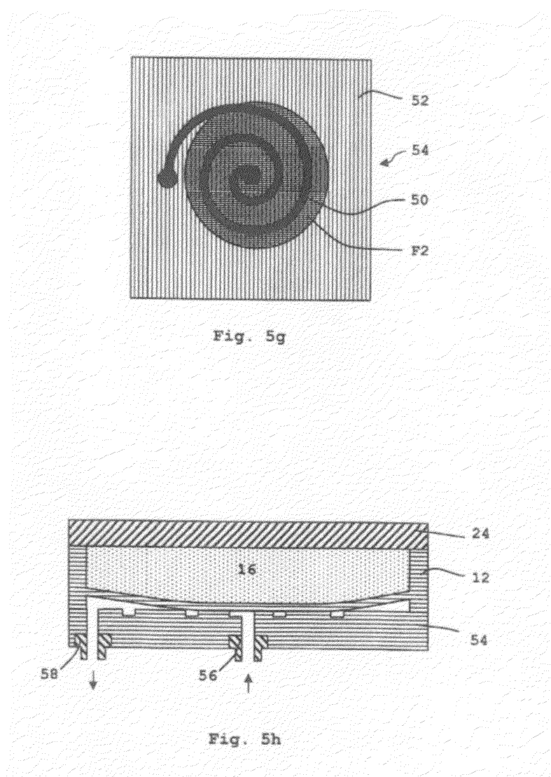

FIG. 5a-5h show a schematic sectional view of the second embodiment of a temperature-compensated flow resistor in different manufacturing steps.

The FIGS. 1a and 1b show in a purely schematic manner a cross section of a temperature-compensated flow resistor 10. The flow resistor 10 comprises a substrate 12 such as an Si substrate in whose upper surface 14 a cavity 16 is placed and in whose lower surface 18 a flow space 20 is placed. A membrane 22 runs between the cavity 16 and the flow space 20, which membrane 22 is an integral component of the Si substrate 12.

The cavity 16 is closed by a cover 24 such as a glass cover, for example, by anodic bonding.

The flow space 20 is closed by a lower cover 26 and a flow conduit 32 is formed between a bottom 28 of the membrane 22 and between a top 30 of the cover 26. An inlet opening 34 with hose connection 36 as well as an outlet opening 38 with hose connection 40 are provided in the lower cover 26. Inlet and outlets 34, 38 are arranged of the edge side so that the flow conduit has a defined length.

A medium 42 such as gas or a liquid is enclosed in the cavity 16.

As can be gathered from the FIG. 1a, 1b, the membrane 22 forms a wall of the cavity 16. If the enclosed medium 42 is heated, the membrane 22 deflects, as is shown in FIG. 1b.

The membrane 22 is also a limitation of the flow conduit 32 at the same time. The membrane 22 is bent in the direction of the arrow 44 by a pressure exerted on the membrane 22 by the temperature expansion of the medium 42 so that a cross section 46 of the flow conduit 32 is constricted. The flow resistance is consequently increased and the flow rate is reduced.

The FIGS. 2a to 2h show a cross section through an individual chip of a wafer in different manufacturing steps.

FIG. 2a shows a silicon wafer 12 that is preferably polished on both sides as starting material.

After a photolithographic masking of an area of the lower surface an etching of the flow space 20 takes place, e.g., by deep reactive ion etching (DRIE etching).

In a further method step according to FIG. 2c a thermal oxidation of the upper and lower surfaces 14, 18 of the substrate 12 with preferably one SiO2 layer 15, 17 takes place and subsequently a separation of, for example, LPCVD nitrite (Si3N4) 17, 19.

FIG. 2d shows the method step of the photographic masking and of the etching of the SiO2 layer 13 and of the Si3N4 layer 17 by, e.g., RIE (reactive ion etching). After the etching the photolithographic mask is removed.

The cavity 16 is subsequently etched according to FIG. 2e. The etching of the cavity 16 preferably takes place by anisotropic KOH (potassium hydroxide) etching. Alternatively, the cavity 16 can also be formed in by DRIE etching.

After removal of the SiO2 layers 13, 15 and of the SiN4 layers 17, 19 a closing of the cavity 16 by a covering 24 takes place by, e.g., a glass wafer with a infill opening 25 preferably bored by ultrasound. The glass wafer 24 is preferably connected to the silicon 12 by anodic bonding.

In another method step according to FIG. 2g the covering of the flow chamber 20 takes place with the lower cover 26. The latter can be constructed as a smooth base plate with hose connections 36, 40, e.g., by a plastic injection molding part. The base plate 26 is connected to the silicon wafer 12 as adhered.

Alternatively, a second, structured glass wafer or silicon wafer with adhered-on hose flanges can also be used.

In a next method step according to FIG. 2h the cavity 16 is filled, for example, in an desiccator, with the medium 42. The infill opening 25 is subsequently closed with a closure 27 that is formed, e.g., by a sealing mass or by adhesive.

The Andrade equation [1] applies for the temperature dependency of the viscosity of pure substances:

$$η = A \cdot {e}^{\frac{b}{T}}$$

with

a=ln(A)
η viscosity
A, b empirical constants
T Absolute temperature

The following applies for water in the range of 1° C. to 99° C.: a=6.994 and b=2036.

The following values results for the viscosity of water at 5° C. and 35° C.:

η_{H2O,5° C.}=1.46 mPa·s

and

η_{H2O,35° C.}=0.72 mPa·s

Thus, the viscosity is reduced in this case by approximately ½. Since η enters linearly into the calculation of the flow rate, this means a doubling of the flow-through amount at the temperature increase from 5° C. to 35° C.

The basic adjustment of the flow takes place in the first embodiment of the flow resistor 10 by a cross-sectional change of the flow conduit 32. The flow is calculated by, e.g., a tubular flow conduit 32 in accordance with the Hagen-Poisseuille equation:

$$Φ = \frac{d V}{d t} = \frac{π \cdot {r}^{4}}{8 \cdot η} \cdot \frac{Δ p}{L}$$

Φ flow
t time
r, L radius and length of the capillary
Δp pressure difference (generates the flow)

It is clear from the equation that a dropping viscosity with rising temperature can be achieved by a lengthening of the conduit or by a reducing of the conduit cross section or diameter.

Given appropriately designed geometries, the increase of the flow rate can be compensated by the temperature-conditioned decrease of the viscosity.

Compensation by changing the conduit cross section 46:

A generalization of the Hagen-Poisseuille equation is given according to [2]:

$$Φ = \frac{1}{{C}_{R}} \cdot \frac{{A}^{2}}{η \cdot L} \cdot Δ p$$

C_{R} geometry-dependent coefficient
A cross-sectional area of the capillary or of the flow conduit
   (C_{R}=8π and A=πr² [symbol] Hagen-Poisseuille).

The following applies according to [3] for flow conduits with rectangular cross section:

$${C}_{R} = \frac{2}{a {\sum }_{i = 1}^{∞} \frac{a}{{α}_{i}^{s}} ( \frac{{α}_{i}}{a} - tanh ( \frac{{α}_{i}}{a} ) )} with a = \frac{h}{b} and {α}_{i} = \frac{π \cdot ( 2 i - 1 )}{2}$$

In it, b and h represent the width and height (depth) of the flow conduit.

If a start is made from typical magnitudes of the MEMS technology in the described, temperature-compensated flow resistors, a C_{R} of approximately 126 results for the rectangular flow conduit 32 with a length of 3 mm, a width of 150 μm and a depth (height) of 15 μm.

A conduit with these dimensions can be realized, for example, by the DRIE etching of a silicon wafer.

A flow of approximately 1 ml/hour for water results with this C_{R}, a Δp of 300 mbar and a conduit length of 3 mm from the Hagen-Poisseuille equation at 5° C. This is a typical dosing for medicaments based on aqueous solutions administered with perfusion pumps. The viscosity is determined in these solutions primarily by the water.

An analogous calculation with the viscosity of water at 35° C. yields a flow of 1 ml/hour at a conduit depth of 12 μm with parameters that are otherwise the same.

Accordingly, for the compensation of the temperature change from 5 to 35° C. the conduit must be approximately 3 μm flatter.

It is assumed in a simplifying manner for the estimation that the membrane 22 does not bend but rather shifts with the increase in volume plane parallel to the conduit surface. The shifting of the membrane 22 by the expansion then corresponds to the reduction of the height of the flow conduit 32. The mechanical properties of the membrane 22 can be disregarded here as long as the medium 42 is a liquid, since the latter is incompressible and the remaining walls of the cavity 16 can be considered as rigid.

The following applies to the expansion of the medium 42:

ΔV=V₀·γ·ΔT
ΔV volume increase (thermal expansion)
V₀ volume of the cavity
ΔT temperature change
γ coefficient of thermal expansion

The following applies with ΔV=b·L·Δh (Δh=shifting of the membrane, and change of the conduit height):

$$Δ h = \frac{Δ V}{b \cdot L} = \frac{{V}_{0} \cdot γ}{b \cdot L} \cdot Δ T .$$

If the same base area (b·L) is used in an appropriate manner for the cavity 16 as for the membrane 22 and 480 μm is assumed for the height of the cavity, then a Δh of 3 μm results at ΔT=30° C. and γ=0.21 10-3 l/K (water).

This corresponds to the necessary change for the compensation of the temperature-conditioned change of the viscosity.

The membrane shifting can be adapted via the height of the cavity in that the higher the cavity is, the greater the shift. A second starting point is the using of another medium than water in the cavity. An alternative is, for example, ethanol, that has with γ=1.1 10-3 l/K a distinctly higher coefficient of expansion and therefore produces a greater shift.

FIG. 3 shows a second embodiment of a temperature-compensated flow resistor 48 in a schematic sectional view in which as regards the flow resistor the same elements are designated with the same reference numbers.

The flow resistor 48 differs from the flow resistor 10 in that a flow conduit 50 is formed in a surface 52 of a lower cover plate 54 lying opposite the membrane 22. In the exemplary embodiment shown the flow conduit 50 is helically designed, whereby an inlet opening 56 is provided in the center and an outlet opening 58 is provided on the edge side.

Upon a thermal expansion of the enclosed medium 42 inside the cavity 16 a pressure is exerted on the membrane 22 in the direction of arrow 60 so that this membrane is pressed against the surface 52 of the cover plate 54 and consequently forms a wall section of the flow conduit 50 and determines the length of the flow conduit.

A contact area F1 covered at a temperature T=T1 by the membrane 22 is shown in cross hatching in FIG. 4a. If the temperature rises to a value T2>T1 the medium 42 expands so that the contact area F1 between membrane 22 and the surface 52 also enlarges. An enlarged contact area F2 at the temperature T2 is shown in cross hatching in FIG. 4b and as a consequence has a lengthening of the effective flow conduit 50.

The flow conduit 50, that is open to the membrane, is closed in areas by the bottom of the membrane 22 so that the length as well as the cross section of the flow conduit 50 is a function of the pressure of the medium 42 and therefore of the temperature. Thus, a flow conduit 50 with differing lengths is produced as a function of the curvature of the membrane 22 and of the size of the contact area F1, F2, and therefore a differently large resistance of the flow conduit is produced.

The resistance of the flow conduit thus varies with the bending of the membrane, that is, with the temperature. Even in this instance the flow rate can be temperature-compensated given the appropriate dimensioning of the components.

FIGS. 5a to 5h show a cross section of the flow resistor 48 in different manufacturing steps.

In the first manufacturing step a silicon wafer 12 is polished on both sides as starting material.

After a photolithographic masking an etching of the flow chamber 20 takes place preferably by DRIE etching. The photolithographic mask is subsequently removed.

FIG. 5c shows the silicon wafer 12 after thermal oxidation, whereby SiO₂ layers 13, 15 are applied respectively on an upper surface 14 and a lower surface 18.

After the photolithographic masking an etching of the SiO₂ layer 13 takes place preferably by RIE etching and then a removal of the photolithographic mask as shown in FIG. 5d. The cavity 16 is subsequently manufactured preferably by DRIE etching, as is shown in FIG. 5e.

In order to cover the flow chamber 20 the base plate 54 is used, that is preferably manufactured from silicon. The flow conduit 50 is let into the surface 52 of the base plate 54 preferably by DRIE etching.

In a preferred embodiment the flow conduit 50 is rectangular in cross section and is helically etched into the surface 52.

The two silicon wafers 12, 54 are connected, preferably by eutectic bonding or by silicon fusion bonding.

FIG. 5c shows a top view of the surface 52 of the cover plate 54 with flow conduit 50 and covered, hatched membrane surface F2.

According to FIG. 5h the cavity 16 is closed by anodic bonding of the upper cover 24 formed as a glass wafer to the silicon wafer 12 under elevated gaseous pressure, e.g., nitrogen N₂. Finally, the hose flanges 58, 56 are connected as adhered to the lower cover 54.

The invention differs from the prior art in that the flow resistor (restriction stretch) as well as a temperature compensation can be integrated into or on a substrate or a chip.

Thus, the flow resistor 10, 48 is realized as a microsystem technical element that has dimensions in the vertical direction in the micrometer range and in the horizontal direction in the micro- or millimeter range. The membranes 22, the cavities 16 and the flow chambers 20 are manufactured from silicon wafer using wet or dry chemical deep etching processes such as anisotropic etching or DRIE etching.

In order to ensure a biocompatibility and a very extensive chemical inactivity the Si substrate 12 is thermally oxidized. After the finishing of the membranes 22 the cavities 16 are closed with the cover 24, that is constructed as a glass wafer and is connected by, for example, anodic bonding to the surface 14 of the substrate.

To the extent that a gas is used as medium 42, the upper cover 24 is bonded on as a glass wafer in an appropriate atmosphere.

To the extent that a liquid is used as medium 42, after the bonding the liquid is filled in through at least one conduit 25 that is subsequently closed again by, e.g., adhesive or casting mass.

The lower cover 26 for the flow chamber 20 of the flow resistor 10 is manufactured as a plastic part, preferably as an injection molding part, and comprises the hose flanges 36, 40.

The lower cover 54 of the flow resistor 48 is manufactured from oxidized silicon, whereby the flow conduit 50 is let into the surface 52 of the cover 54, and whereby different etching methods such as isotropic etching with KOH or TMAH (tetramethylammonium hydroxide) and DRIE etching are used.

After the covering of the Si wafers 12 comprising the cavities 16 and flow chamber 20 preferably with glass, an individualization into chips and the placing of the hose connections 36, 40, 56, 58, for example, by adhesion takes place.

1. A flow resistor (48) comprising a flow conduit (50) with an inlet opening (56) and an outlet opening (58) as well as a membrane (22) forming at least in sections a wall of the flow conduit (50), whereby a cross section of the flow of the flow conduit (50) can be varied by exerting pressure on the membrane (22), characterized in that the flow resistor (48) comprises a cavity (16) containing a medium (42) with a positive temperature coefficient and comprises a flow chamber (20), that the membrane (22) separates the cavity (16) from the flow chamber (20) and is both the wall of the cavity (16) as well as at least in sections the wall of the flow conduit (50), that the flow conduit (50) is constructed as a helical recess, open to the membrane (22), in a surface (52) of a lower cover (54) that closes the flow chamber (20), that an inflow opening (56) is arranged in the center of an area fixed by the flow conduit (50) and that an outflow opening (58) is arranged on the edge side in such a manner that the flow conduit (50) can be varied as a function of the temperature T of the medium (42) as regards the cross-section of its flow as well as regards its length on which the membrane (22) rests.

2. The flow resistor according to claim 1, characterized in that the cavity (16) is formed in an upper surface (14) of a substrate (12) and that the flow chamber (20) is formed in a lower surface (18) of the substrate (12), and that the cavity (16) is closed by an upper cover (24) and the flow chamber is closed by the lower cover (54).

3. The flow resistor according to claim 1, characterized in that the flow conduit (50) has a rectangular or semi-circular cross section.

4. The flow resistor according to claim 1, characterized in that the area fixed by the flow conduit (50) corresponds substantially to an area of the membrane (22).

5. The flow resistor according to claim 2, characterized in that the upper cover (24) is a glass cover, preferably as part of a glass wafer, that is connected by anodic bonding to the Si substrate.

6. The flow resistor according to claim 2, characterized in that the substrate (12) is an Si substrate or a plastic molded part.

7. The flow resistor according to claim 2, characterized in that the membrane (22) running between the cavity (16) and the flow chamber (20) is constructed as an integral component of the substrate (12) and that the membrane (22) is produced using a wet or dry chemical process.

8. The flow resistor according to claim 6, characterized in that the Si substrate (12) is thermally oxidized.

9. The flow resistor according to claim 1, characterized in that the medium (42) is a gas or a liquid.

10. The flow resistor according to claim 1, characterized in that the lower cover (54) is a plastic molded part such as an injection molding part.

11. The flow resistor according to claim 1, characterized in that the lower cover (54) is manufactured from an Si substrate.
